(19) United States
(12) Patent Application Publication
(10) Pub. No.: US 2013/0267274 A1
(43) Pub. Date: Oct. 10, 2013

(54) EXPANSION DEVICE

(71) Applicants: Chien-Ming Hsu, Taipei City (TW); Kuo-Chu Liao, Taipei City (TW); Chung-Yuan Kuang, Taipei City (TW); Chiuan-Jian Huang, Taipei City (TW); Fu-Kai Tsai, Taipei City (TW)

(72) Inventors: Chien-Ming Hsu, Taipei City (TW); Kuo-Chu Liao, Taipei City (TW); Chung-Yuan Kuang, Taipei City (TW); Chiuan-Jian Huang, Taipei City (TW); Fu-Kai Tsai, Taipei City (TW)

(73) Assignee: ASUSTeK COMPUTER INC., Taipei City (TW)

(21) Appl. No.: 13/845,030

(22) Filed: Mar. 17, 2013

Related U.S. Application Data
(60) Provisional application No. 61/621,971, filed on Apr. 9, 2012.
(60) Provisional application No. 61/621,585, filed on Apr. 9, 2012.

(30) Foreign Application Priority Data
Jan. 31, 2013 (TW) 102103814

(51) Int. Cl. H04M 1/02

(52) U.S. Cl. CPC H04M 1/026
USPC 455/556.1

(57) ABSTRACT

An expansion device includes a casing and a wireless transceiving module. The casing includes a receiving slot suitable for accommodating a mobile communication device, wherein the mobile communication device includes at least an antenna to operate at least one communication band. When the mobile communication device is accommodated in the receiving slot, the wireless transceiving module receives electromagnetic wave at the communication band, generates at least one radio frequency signal, and wirelessly couples the radio frequency signal to the antenna in the mobile communication device.

### CROSS-REFERENCE TO RELATED APPLICATION

This application claims the priority benefits of U.S. provisional application Ser. No. 61/621,971, filed on Apr. 9, 2012, and U.S. provisional application Ser. No. 61/621,585, filed on Apr. 9, 2012, and Taiwan application serial no. 102103814, filed on Jan. 31, 2013. The entirety of each of the above-mentioned patent applications is hereby incorporated by reference herein and made a part of this specification.

### BACKGROUND OF THE INVENTION

1. Field of the Invention

The invention relates to an expansion device.

2. Description of the Related Art

As the size of a mobile communication device becomes smaller, the display screen of the mobile communication device becomes smaller. In order to meet requirements on the size of the display screen for users, the mobile communication device combined with an expansion device which includes a bigger display screen is developed. For example, the mobile communication device may be disposed in the expansion device with a bigger display screen, the mobile communication device is taken as a processor of the system, and the display screen of the expansion device displays an image, so as to enlarge the display size.

However, when the mobile communication device is disposed in the expansion device, communication quality of an antenna of the mobile communication device may be affected due to a shielding effect from the expansion device.

### BRIEF SUMMARY OF THE INVENTION

An expansion device can avoid that the communication quality of the mobile communication device is declined when it is disposed in the expansion device.

An expansion device includes a casing and a wireless transceiving module. The casing includes a receiving slot for accommodating a mobile communication device. The mobile communication device includes at least one antenna to operate at least one communication band. When the mobile communication device is accommodated in the receiving slot, the wireless transceiving module receives electromagnetic wave at least one communication band and generates at least one radio frequency signal accordingly, and the wireless transceiving module wirelessly couples the radio frequency signal to the antenna of the mobile communication device.

After the mobile communication device is inserted into the expansion device, the wireless transceiving module in the expansion device receives external electromagnetic wave, and transmits signals to the antenna of the mobile communication device via wireless coupling. Thus, whether the casing of the expansion device is made of metal or not, the communication quality of the mobile communication device is effectively improved when it is disposed in the expansion device.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic system in a first embodiment.

FIG. 2 is a block diagram showing a mobile communication device and a wireless transceiving module in the first embodiment.

FIG. 3 is a block diagram showing a transceiver in a second embodiment.

FIG. 4 is a block diagram showing a transceiver in a third embodiment.

FIG. 5 is a block diagram showing a mobile communication device and a wireless transceiving module in a fourth embodiment.

FIG. 6 is a block diagram showing a mobile communication device and a wireless transceiving module in a fifth embodiment.

FIG. 7 is a block diagram showing a mobile communication device and a wireless transceiving module in a sixth embodiment.

### DETAILED DESCRIPTION OF THE EMBODIMENTS

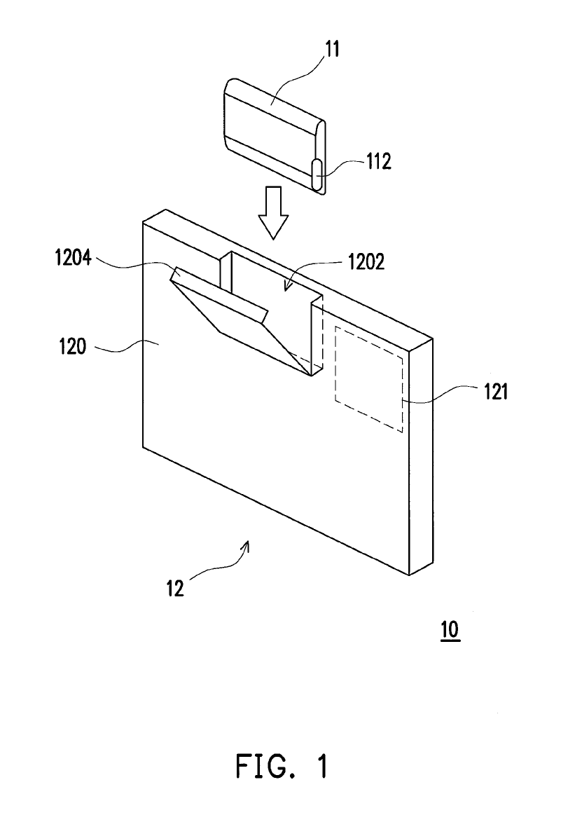

FIG. 1 is a schematic diagram showing an electronic system in a first embodiment. Please refer to FIG. 1, the electronic system 10 includes a mobile communication device 11 and an expansion device 12. The mobile communication device 11 may be a smart mobile phone or a portable electronic device which has various wireless communication functions. The mobile communication device 11 includes an antenna 112, and the antenna 112 operates at a communication band and receives electromagnetic wave at the communication band.

The expansion device 12 includes a casing 120 and a wireless transceiving module 121. The casing 120 includes a receiving slot 1202 which can accommodate the mobile communication device 11. For example, in the embodiment, the mobile communication device 11 is detachably accommodated in the receiving slot 1202. Furthermore, a side wall of the receiving slot 1202 may be formed by an openable back cover 1204. The openable back cover 1204 can open or close relative to the casing 120 to dispose the mobile communication device 11 in the receiving slot 1202.

When the mobile communication device 11 is accommodated in the receiving slot 1202, the communication quality of the antenna 112 is declined greatly due to a shielding effect of the casing 120 especially made of metal. Thus, the wireless transceiving module 121 of the expansion device 12 can operate at the communication band adapted to the antenna 112. When the mobile communication device 11 is accommodated in the receiving slot 1202, the mobile communication device 11 uses the wireless transceiving module 121 to receive the electromagnetic wave out of the casing 120 or transmit the electromagnetic wave to the outside of the casing 120. The wireless transceiving module 121 can replace the antenna 112 to receive the electromagnetic wave and generate a radio frequency signal accordingly, and it wirelessly couples the radio frequency signal to the antenna 112 of the mobile communication device 11.

Thus, when the antenna 112 cannot receive and transmit the electromagnetic wave successfully due to the effect of the casing 120, the mobile communication device 11 uses the wireless transceiving module 121 of the expansion device 12 to receive and transmit the electromagnetic wave. Additionally, the mobile communication device 11 and the wireless transceiving module 121 are connected via coupling effect between the antenna 112 and the wireless transceiving module 121 instead of cables, which makes the signal transmission more efficient.

On the other hand, in the embodiment, after the mobile communication device 11 is accommodated in the receiving slot 1202, the mobile communication device 11 boots or enables a touch control display panel of the expansion device 12, and transfers data to the expansion device 12 via a data transferring interface, or receives a touch control command of the user via the touch control display panel of the expansion device 12 to display a corresponding image. For example, an image which should have been displayed at a screen of the mobile communication device 11 is displayed at the touch control display panel of the expansion device 12.

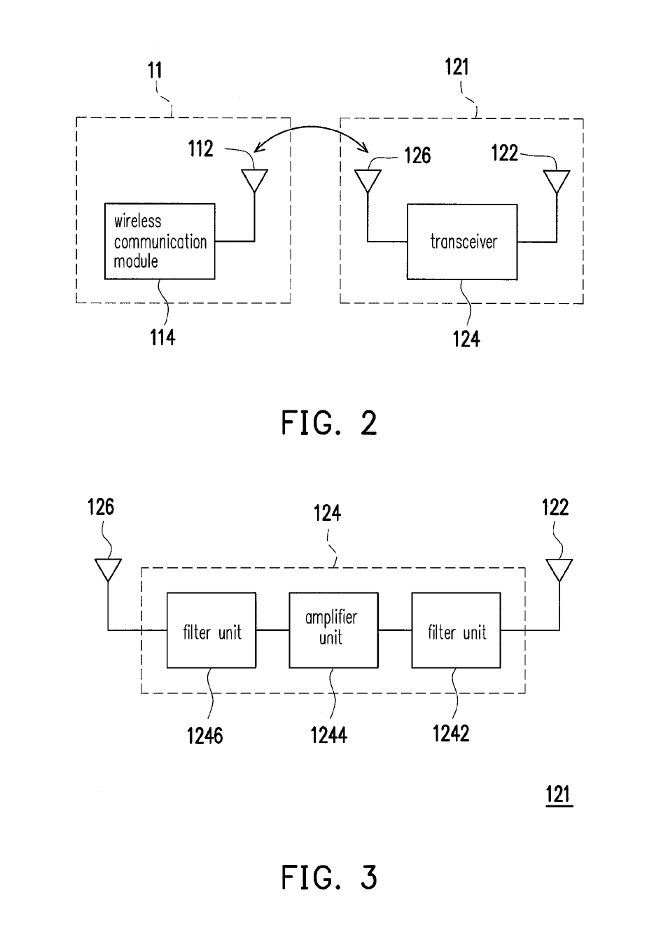

FIG. 2 is a block diagram showing a mobile communication device and a wireless transceiving module in the first embodiment. As shown in FIG. 2, the mobile communication device 11 includes an antenna 112 and a wireless communication module 114. The antenna 112 can operate at a communication band and receive electromagnetic wave at the communication band. The wireless communication module 114 processes signals from the antenna 112 or transmits signals to the antenna 112, and provides a wireless communication function corresponding to the communication band.

The wireless transceiving module 121 of the expansion device 12 includes an expansion antenna 122, a transceiver 124 and a coupling antenna 126. The expansion antenna 122 receives the electromagnetic wave at the communication band adapted to the antenna 112, and transforms the received electromagnetic wave to a receiving signal. The transceiver 124 is connected to the expansion antenna 122 to process the receiving signal and generate the radio frequency signal. The coupling antenna 126 is connected to the transceiver 124 to wirelessly couple the radio frequency signal to the antenna 112. For example, the radio frequency signal is transmitted to the antenna 112 in a form of electromagnetic wave.

FIG. 3 is a block diagram showing a transceiver in a second embodiment. As shown in FIG. 3, the wireless transceiving module 121 includes an expansion antenna 122, a transceiver 124 and a coupling antenna 126. The expansion antenna 122 and the coupling antenna 126 are illustrated above, which is omitted herein.

The transceiver 124 includes a filter unit 1242, an amplifier unit 1244 and a filter unit 1246. The filter unit 1242 is connected to the expansion antenna 122 to filter the receiving signal from the expansion antenna 122. The amplifier unit 1244 is connected between the filter unit 1242 and the coupling antenna 126 to amplify the signal from the filter unit 1242. Furthermore, the filter unit 1246 filters the signal from the amplifier unit 1244 to generate the radio frequency signal. The coupling antenna 126 wirelessly couples the radio frequency signal to the antenna (such as the antenna 112 in FIG. 1) of the mobile communication device.

Moreover, in the embodiment, the transceiver of the wireless transceiving module may include multiple amplifier units and multiple filter units to filter and amplify signals at different sub bands, and a selector switch of the transceiver is used to select a signal at one specific sub band.

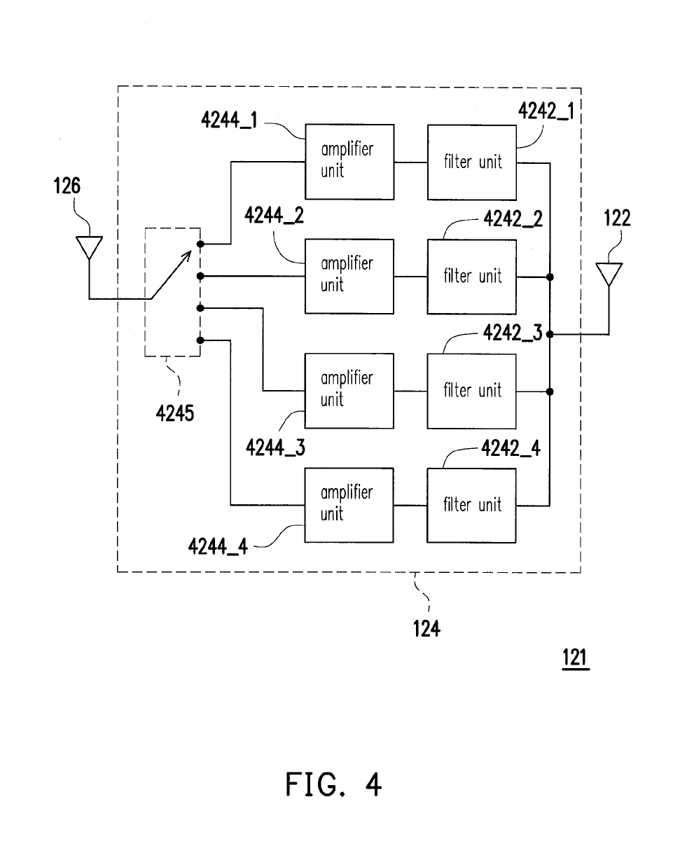

FIG. 4 is a block diagram showing a transceiver in a third embodiment. As shown in FIG. 4, the coupling antenna 122 is a multi-band antenna, and the transceiver 124 includes filter units 4242_1 to 4242_4, amplifier units 4244_1 to 4244_4 and a selector switch 4245. The filter units 4242_1 to 4242_4 are connected to the coupling antenna 122, respectively, and filter the receiving signal from the coupling antenna 122.

A pass band of each of the filter units 4242_1 to 4242_4 corresponds to one sub band of the communication band. For example, the communication band may be a long term evolution (LTE) communication band, and the pass bands of the filter unit 4242_1 to 4242_4 may correspond to the four sub bands of the LTE communication band. After the filter units 4242_1 to 4242_4 filter the receiving signals from the expansion antenna 122, they generate signals at the sub bands, respectively

The amplifier units 4244_1 to 4244_4 are connected to the filter units 4242_1 to 4242_4 and amplify the signals from the filter units 4242_1 to 4242_4. The selector switch 4245 is connected between the amplifier units 4244_1 to 4244_4 and the coupling antenna 126 to switch a connection between one of the amplifier units 4244_1 to 4244_4 and the coupling antenna 126, and select a signal from the amplifier units 4244_1 to 4244_4 as the radio frequency signal. Moreover, the selector switch 4245 transmits the radio frequency signal to the coupling antenna 126 to make the coupling antenna 126 wirelessly couple the radio frequency signal at one specific sub band to the antenna of the mobile communication device.

If the expansion antenna 122, the transceiver 124 and the coupling antenna 126 is taken as a signal transmission module corresponding to one communication band, the wireless transceiving module of the expansion device may include multiple signal transmission modules, and each of the signal transmission modules corresponds to a communication band, respectively

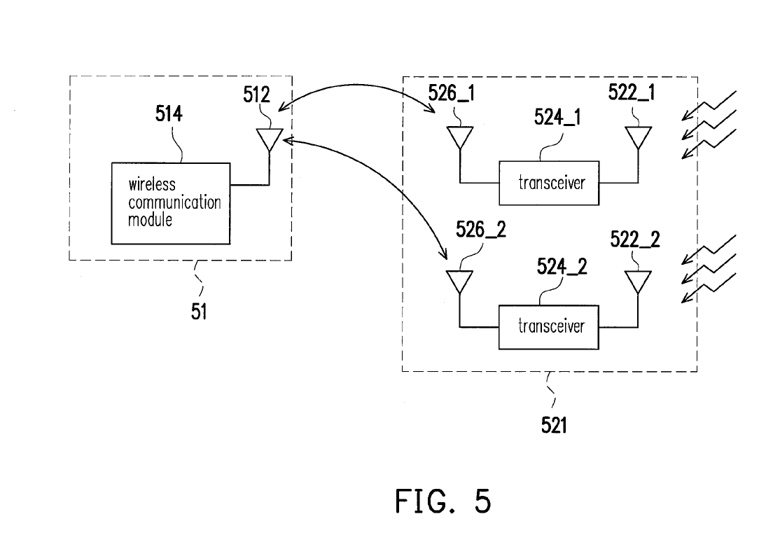

FIG. 5 is a block diagram showing a mobile communication device and a wireless transceiving module in a fourth embodiment. As shown in FIG. 5, the mobile communication device 51 includes an antenna 512 and a wireless communication module 514. The antenna 512 may be a dual-band antenna operating at the first communication band and the second communication band. In other words, the antenna 512 receives the electromagnetic wave at the first communication band and the second communication band. The wireless communication module 514 is connected to the antenna 512 to process signals from the antenna 512 and provides a corresponding wireless communication function.

For example, in the embodiment, the first communication band may be a Bluetooth (BT) communication band, the second communication band may be an LTE communication band, and the wireless communication module 514 provides at least one wireless communication function which meets the Bluetooth or LTE communication standard, which is not limited herein.

The wireless transceiving module 521 includes an expansion antenna 522_1, a transceiver 524_1 and a coupling antenna 526_1, and the expansion antenna 522_1, the transceiver 524_1 and the coupling antenna 526_1 can be taken as a first signal transmission module. Furthermore, the wireless transceiving module 521 further includes an expansion antenna 522_2, a transceiver 524_2 and a coupling antenna 526_2, and the expansion antenna 522_2, the transceiver 524_2 and the coupling antenna 526_2 can be taken as a second signal transmission module. The difference between the first signal transmission module and the second signal transmission module is their corresponding communication band. The first signal transmission module transmits signals at the first communication band, and the second signal transmission module transmits signals at the second communication band.

For example, the wireless transceiving module 521 receives the electromagnetic wave at the first communication band via the expansion antenna 522_1 to generate the first receiving signal. The transceiver 524_1 processes the first receiving signal to generate the first radio frequency signal. The coupling antenna 526_1 wirelessly couples the first radio frequency signal to the antenna 512. The wireless transceiving module 521 may also receive the electromagnetic wave at the second communication band via the expansion antenna 522_2 to generate the second receiving signal. The transceiver 524_2 processes the second receiving signal to generate the second radio frequency signal. The second radio frequency signal is wirelessly coupled to the antenna 512 via the coupling antenna 526_2.

The coupling antennas 526_1 and 526_2 of the wireless transceiving module 521 wirelessly couple the radio frequency signal to the antenna 512 of the mobile communication device 51. In other words, the wireless transceiving module 521 and the mobile communication device 51 are signally coupled via multiple coupling antennas and one antenna. However, the mobile communication device 51 may include multiple antennas. Thus, the wireless transceiving module 521 and the mobile communication device 51 can be signally coupled via multiple coupling antennas and multiple antennas. For example, when the mobile communication device 51 includes multiple antennas, one antenna receives signals from the coupling antenna 526_1, and the other antenna receives signals from the coupling antenna 526_2.

The expansion antenna of the expansion device may also receive the electromagnetic wave at multiple communication band, and determines to choose a radio frequency signal corresponding to which communication band should be wirelessly coupled to the antenna of the mobile communication device via the integrated switch of the expansion device. Thus, the number of the expansion antennas of the expansion device is decreased, which saves space for disposing additional expansion antennas in the expansion device.

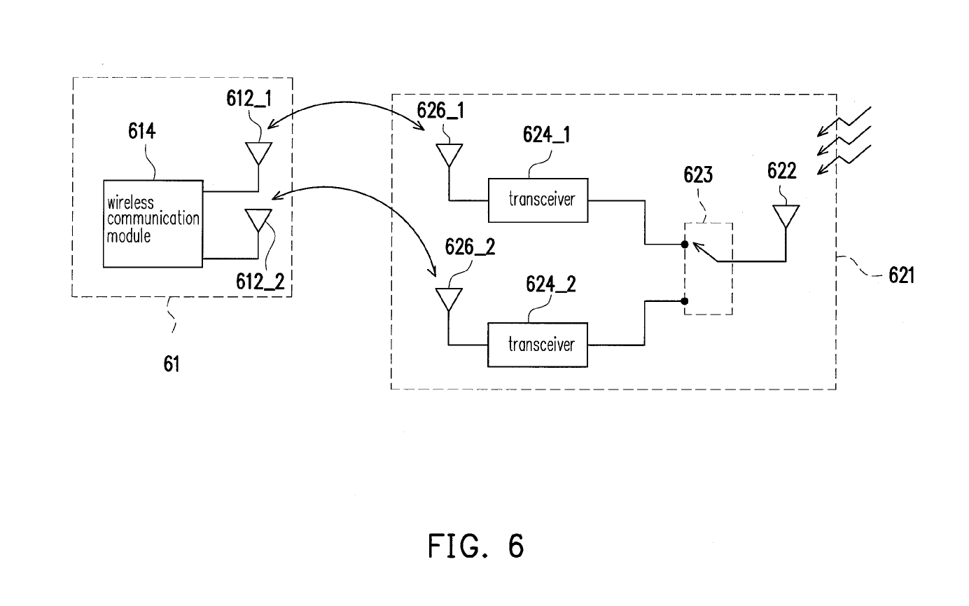

FIG. 6 is a block diagram showing a mobile communication device and a wireless transceiving module in a fifth embodiment. As shown in FIG. 6, the mobile communication device 61 includes an antenna 612_1, an antenna 612_2 and a wireless communication module 614. The antenna 612_1 receives electromagnetic wave at the first communication band, and the antenna 612_2 receives electromagnetic wave at the second communication band. The first communication band and the second communication band may be a Bluetooth communication band or an LTE communication band, which is not limited herein. The wireless communication module 614 is similar to the wireless communication module 514 in FIG. 5, which is omitted herein.

The wireless transceiving module 621 includes an expansion antenna 622, an integrated switch 623, a transceiver 624_1, a transceiver 624_2, a coupling antenna 626_1 and a coupling antenna 626_2. The transceiver 624_1 and the coupling antenna 626_1 are similar to the transceiver 524_1 and the coupling antenna 526_1 in FIG. 5, respectively, and the transceiver 624_2 and the coupling antenna 626_2 are similar to the transceiver 524_2 and the coupling antenna 526_2 in FIG. 5, respectively, which is omitted herein.

The expansion antenna 622 receives electromagnetic wave at the first communication band and the second communication band. Moreover, the expansion antenna 622 transforms the electromagnetic wave at the first communication band to the first receiving signal, and transforms the electromagnetic wave at the second communication band to the second receiving signal. The integrated switch 623 includes three connecting terminals. The first connecting terminal of the integrated switch 623 is electrically connected to the expansion antenna 622, and the second connecting terminal and the third connecting terminal of the integrated switch 623 are electrically connected to the transceiver 624_1 and the transceiver 624_2, respectively. In operation, the integrated switch 623 connects the first connecting terminal to the second connecting terminal or the third connecting terminal to connect the expansion antenna 622 to one of the transceiver 624_1 and the transceiver 624_2.

In other words, the integrated switch 623 switches the connection between the expansion antenna 622 and the transceiver 624_1 to 624_2, so as to transmit the signals from the expansion antenna 622 to the transceiver 624_1 or the transceiver 624_2. For example, when the integrated switch 623 connects the expansion antenna 622 and the transceiver 624_1, the transceiver 624_1 receives the signals from the expansion antenna 622. When the integrated switch 623 connects the expansion antenna 622 and the transceiver 624_2, the transceiver 624_2 receives the signals from the expansion antenna 622.

The wireless transceiving module 621 controls the integrated switch 623 according to the operation of the mobile communication device 61. For example, when the mobile communication device 61 operates at the first communication band, the wireless transceiving module 621 controls the integrated switch 623 to connect the expansion antenna 622 and the transceiver 624_1. The transceiver 624_1 processes the first receiving signal to generate the first radio frequency signal, and the coupling antenna 626_1 wirelessly couples the first radio frequency signal to the antenna 612_1. Similarly, when the mobile communication device 61 operates at the second communication band, the wireless transceiving module 621 controls the integrated switch 623 to connect the expansion antenna 622 and the transceiver 624_2. The transceiver 624_2 processes the second receiving signal to generate the second radio frequency signal, and the coupling antenna 626_2 wirelessly couples the second radio frequency signal to the antenna 612_2.

The mobile communication device may also include multiple wireless communication modules and multiple antennas. Each of the wireless communication modules can provide a wireless communication function supporting one or more wireless communication technologies, and the wireless communication modules can receive and send out signals via a same antenna.

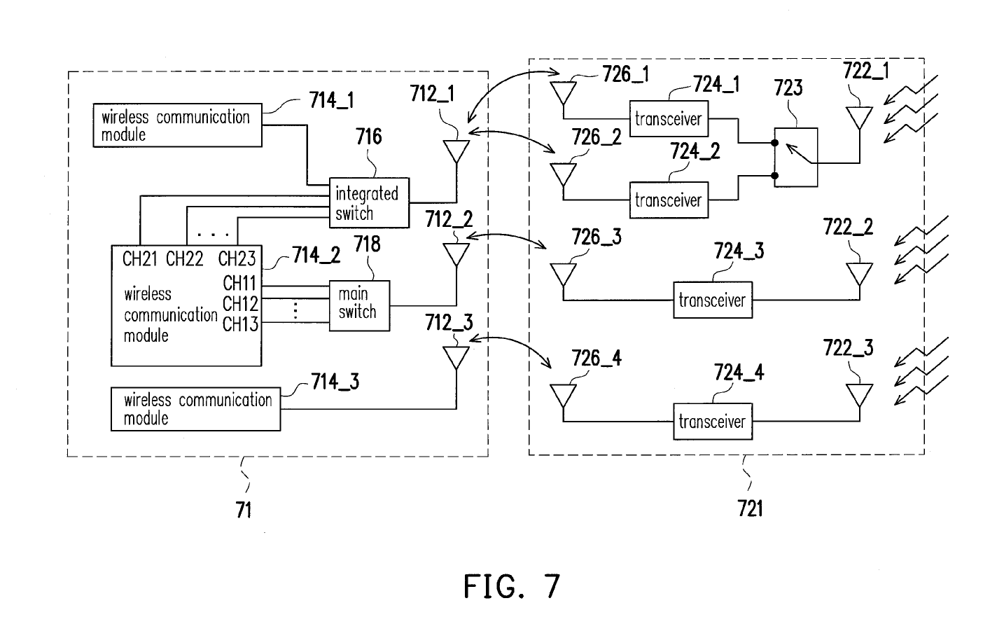

FIG. 7 is a block diagram showing a mobile communication device and a wireless transceiving module in a sixth embodiment. As shown in FIG. 7, the mobile communication device 71 includes antennas 712_1 to 712_3, wireless communication modules 714_1 to 714_3, an integrated switch 716 and a main switch 718. The antenna 712_1 receives and sends out electromagnetic wave at the first communication band (such as a Bluetooth communication band or a wireless fidelity (WiFi) communication band) and the second communication band (such as an LTE communication band or a 3G communication band).

In other words, the antenna 712_1 is a combination of the BT/WiFi antenna and the LTE/3G diversity antenna of the mobile communication device 71. Furthermore, the antenna 712_2 is taken as a main antenna of the mobile communication device 71, and the antenna 712_3 is taken as a global positioning system (GPS) antenna of the mobile communication device 71. Thus, the antenna 712_2 may operate at a 2G communication band, a 3G communication band and an LTE communication band, and the antenna 712_3 may operate at a GPS communication band, which is not limited herein.

The wireless communication module 714_1 provides a wireless communication function conforming to the Bluetooth and WiFi communication standard. The wireless communication module 714_2 provides a wireless communication function conforming to the 2G, 3G and LTE communication standard and so on.

Furthermore, the wireless communication module 714_2 includes a plurality of main channels CH11 to CH13 and a plurality of diversity channels CH21 to CH23. The main channels CH11 to CH13 transmits the signals from the antenna 712_2 (the main antenna), and the diversity channels CH21 to CH23 transmit diversity signals at the LTE/3G communication band, which is not limited herein. The wireless communication module 714_3 provides a wireless communication function conforming to GPS communication standard.

The integrated switch 716 is electrically connected to the antenna 712_1, the wireless communication module 714_1 and the diversity channels CH21 to CH23 of the wireless communication module 714_2 to connect the antenna 712_1 to the wireless communication module 714_1 or one of the diversity channels CH21 to CH23. Thus, signals from the antenna 712_1 are transmitted to the wireless communication module 714_1 or one of the diversity channels CH21 to CH23 via the integrated switch 716.

The mobile communication device 71 controls the integrated switch 716 according to a wireless communication function to be executed. For example, when the mobile communication device 71 executes a wireless communication function conforming to a BT/WiFi communication standard, it controls the integrated switch 716 to connect the antenna 712_1 to the wireless communication module 714_1, and the antenna 712_1 receives or sends out signals at the BT/WiFi communication band, which is not limited herein. Relatively, when the mobile communication device 71 improves data transferring speed, it controls the integrated switch 716 to connect the antenna 712_1 to one of the diversity channels CH21 to CH23, and the antenna 712_1 receives diversity signals at the LTE/3G communication band, which is not limited herein.

The main switch 718 is electrically connected to the antenna 712_2 and the main channels CH11 to CH12 and connects the antenna 712_2 to one of the main channels CH11 to CH12. Similarly, the mobile communication device 71 controls the main switch 718 according to a wireless communication function to be executed. For example, the main channels CH11 and CH12 may transmit a transmitting signal and a receiving signal at 2G communication band, and the main channel CH13 may transmit a signal at 3G communication band, which is not limited herein.

Consequently, when the mobile communication device 71 executes a function conforming to a wireless communication function conforming to 2G standard, the antenna 712_2 is connected to the main channel CH11 or CH12 via the main switch 718. Relatively, when the mobile communication device 71 executes a function conforming to a wireless communication function conforming to 3G standard, the antenna 712_2 is connected to the main channel CH13 via the main switch 718, which is not limited herein.

Furthermore, the wireless transceiving module 721 includes expansion antennas 722_1 to 722_3, an integrated switch 723, transceivers 724_1 to 724_4 and coupling antennas 726_1 to 726_4. The expansion antenna 722_1, the integrated switch 723, the transceiver 724_1, the transceiver 724_2, the coupling antenna 726_1 and the coupling antenna 726_2 are similar to the expansion antenna 622, the integrated switch 623, the transceiver 624_1, the transceiver 624_2, the coupling antenna 626_1 and the coupling antenna 626_2 in FIG. 6, which is omitted herein.

The expansion antenna 722_1 receives electromagnetic wave at the first communication band (such as the Bluetooth or WiFi communication band) and the second communication band (such as the LTE or 3G communication band), and transforms the electromagnetic wave to the first receiving signal and the second receiving signal. Moreover, the wireless transceiving module 721 controls the integrated switch 723 according to operation of the mobile communication device 71.

When the expansion antenna 722_1 is connected to the transceiver 724_1, the transceiver 724_1 processes the first receiving signal to the first radio frequency signal, and the coupling antenna 726_1 wirelessly couples the first radio frequency signal to the antenna 712_1 in a form of electromagnetic wave to make the antenna 712_1 receive a signal (the first radio frequency signal) at the first communication band.

When the expansion antenna 722_1 is connected to the transceiver 724_2, the transceiver 724_2 processes the second receiving signal to the second radio frequency signal, and the coupling antenna 726_2 wirelessly couples the second radio frequency signal to the antenna 712_1 in a form of electromagnetic wave to make the antenna 712_1 receive a diversity signal (the second radio frequency signal) at the second communication band.

Furthermore, the expansion antenna 722_2, the transceiver 724_3 and the coupling antenna 726_3 are similar to the expansion antenna 122, the transceiver 124 and the coupling antenna 126 in FIG. 2. The expansion antenna 722_2 receives electromagnetic wave at third communication band and transforms the received electromagnetic wave to a third receiving signal. The transceiver 724_3 processes the third receiving signal to the third radio frequency signal, and the coupling antenna 726_3 wirelessly couples the third radio frequency signal to the antenna 712_2 in a form of electromagnetic wave.

Similarly, the expansion antenna 722_3 receives electromagnetic wave at a fourth communication band (such as GPS communication band) and transforms the received electromagnetic wave to a fourth receiving signal. The transceiver 724_4 processes the fourth receiving signal to the fourth radio frequency signal, and the coupling antenna 726_4 wirelessly couples the fourth radio frequency signal to the antenna 712_3 in a form of the electromagnetic wave, so as to make the antenna 712_3 receive a signal (the fourth radio frequency signal) at the fourth communication band.

In sum, the expansion device includes the wireless transceiving module. When the mobile communication device is accommodated in the expansion device, the wireless transceiving module of the expansion device receives electromagnetic wave at one or more communication band, and wirelessly couples the radio frequency signals at the communication bands to the antenna of the mobile communication device, so as to improve the communication quality of the mobile communication device disposed in the expansion device.

Moreover, the expansion device integrates the expansion antenna via the integrated switch of the wireless transceiving module, and receives the electromagnetic wave at multiple communication bands by using single expansion antenna. Thus, the number of the expansion antennas is decreased and space in the expansion device is saved. Furthermore, the antennas in the mobile communication device are integrated to decrease its number and save space.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An expansion device, comprising:
a casing including a receiving slot to accommodate a mobile communication device, wherein the mobile communication device includes at least one antenna to operate at least one communication band; and
a wireless transceiving module, disposed in the casing, wherein when the mobile communication device is accommodated in the receiving slot, the wireless transceiving module receives electromagnetic wave at the communication band, generates at least one radio frequency signal accordingly, and wirelessly couples the radio frequency signal to the antenna of the mobile communication device.

2. The expansion device according to claim 1, wherein the communication band includes a first communication band, the radio frequency signal includes a first radio frequency signal, and the wireless transceiving module includes:
a first expansion antenna receiving the electromagnetic wave at the first communication band to generate a first receiving signal; and
a first transceiver processing the first receiving signal to generate the first radio frequency signal; and
a first coupling antenna coupling the first radio frequency signal to the antenna.

3. The expansion device according to claim 2, wherein the first transceiver includes:
a filter unit connected to the first expansion antenna to filter the first receiving signal; and
an amplifier unit connected between the filter unit and the first coupling antenna to amplify a signal from the filter unit and generate the first radio frequency signal.

4. The expansion device according to claim 2, wherein the first communication band includes a plurality of sub bands, and the first transceiver includes:
a plurality of filter units connected to the first coupling antenna to filter the first receiving signal respectively, wherein pass bands of the filter units correspond to the sub bands;
a plurality of amplifier units connected to the filter units to amplify signals from the filter units; and
a selector switch connected between the amplifier unit and the first coupling antenna to select a signal from the amplifier units as the first radio frequency signal and transmit the first radio frequency signal to the first coupling antenna.

5. The expansion device according to claim 2, wherein the communication band further includes a second communication band, the radio frequency signal further includes a second radio frequency signal, and the wireless transceiving module further includes:
a second expansion antenna receiving the electromagnetic wave at the second communication band to generate a second receiving signal;
a second transceiver connected to the second expansion antenna to process the second receiving signal and generate the second radio frequency signal; and
a second coupling antenna connected to the second transceiver to wirelessly couple the second radio frequency signal to the antenna.

6. The expansion device according to claim 2, wherein the communication band further includes a second communication band, the radio frequency signal further includes a second radio frequency signal, the first expansion antenna receives the electromagnetic wave at the second communication band to generate a second receiving signal, and the wireless transceiving module further includes:
a second transceiver;
an integrated switch electrically connected to the first expansion antenna, the first transceiver and the second transceiver, wherein the integrated switch connects the first expansion antenna to one of the first transceiver and the second transceiver, and when the integrated switch connects the first expansion antenna to the second transceiver, the second transceiver processes the second receiving signal to generate the second radio frequency signal; and
a second coupling antenna electrically connected to the second transceiver and coupling the second radio frequency signal to the antenna.

7. The expansion device according to claim 6, wherein the antenna includes a first antenna and a second antenna, the first coupling antenna wirelessly couples the first radio frequency signal to the first antenna, and the second coupling antenna wirelessly couples the second radio frequency signal to the second antenna.

8. The expansion device according to claim 6, wherein the antenna includes a first antenna, the first coupling antenna wirelessly couples the first radio frequency signal to the first antenna, and the second coupling antenna wirelessly couples the second radio frequency signal to the first antenna.

9. The expansion device according to claim 1, wherein the radio frequency signal includes a first radio frequency signal and a second radio frequency signal, the wireless transceiving module wirelessly couples the first radio frequency signal to a first antenna of the antenna via a first coupling antenna, and the wireless transceiving module wirelessly couples the second radio frequency signal to the first antenna via a second coupling antenna.

10. The expansion device according to claim 9, wherein the mobile communication device further includes:
a first wireless communication module including a plurality of main channels and a plurality of diversity channels;
a second wireless communication module; and
an integrated switch electrically connected to the first antenna, the diversity channels and the second wireless communication module and connecting the first antenna to the second wireless communication module or one of the diversity channels.

11. The expansion device according to claim 10, wherein the radio frequency signal further includes a third radio frequency signal, the wireless transceiving module wirelessly couples the third radio frequency signal to a second antenna of the antenna via a third coupling antenna, and the mobile communication device further includes:
a main switch electrically connected to the second antenna and the main channels and connecting the second antenna to one of the main channels.

12. The expansion device according to claim 10, wherein the radio frequency signal further includes a fourth radio frequency signal, the wireless transceiving module wirelessly couples the fourth radio frequency signal to a third antenna of the antenna via a fourth coupling antenna, and the mobile communication device further includes a third wireless communication module electrically connected to the third antenna.
